(19) United States
(12) Patent Application Publication
(10) Pub. No.: US 2005/0017785 A1
(43) Pub. Date: Jan. 27, 2005

(54) Cascadable configuration of sets of switches

(75) Inventor: Fritz Albicker, Wangen-Haslach (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 10/865,563

(22) Filed: Jun. 9, 2004

(30) Foreign Application Priority Data
Jul. 25, 2003 (DE) 103 33 911.6

(51) Int. Cl. H04M 11/00

(52) U.S. Cl. 327/382

(57) ABSTRACT

A cascadable configuration of sets of switches has call-up, inquiry, and reach-through terminals in a defined mutual configuration. A switching region of each set of switches can have a digital, a binary-coded or an analog switch. A reduction in the complexity of the cascade circuit is achieved by way of a parallel bus-like connection of at least one input-side reach-through terminal to an output-side reach-through terminal which in a subsequent set of switches is disposed at the geometrical position of the call-up terminal thereof. Therefore it is possible to connect downstream of the first set of switches (cascade) as many sets of switches as there are reach-through lines on the sets of switches.

### BACKGROUND OF THE INVENTION

1. Field of the Invention

The invention concerns a cascadable configuration of sets of switches with a number of call-up and inquiry terminals.

In installing sets of switches that are intended to offer the option of cascading in the sense of a mechanical succession, each switch of a set requires its own individual wiring. That involves an extremely high level of circuitry complication and cost. The large amount of space required for the individual connecting lines results in that it will be necessary to provide a correspondingly large amount of space for the overall circuit. The degree of clarity of the layout of the overall circuitry is thereby limited and subsequent additional installations and expansions can only be implemented with difficulty.

### SUMMARY OF THE INVENTION

It is accordingly an object of the invention to provide a cascadable configuration of sets of switches which overcomes the above-mentioned disadvantages of the prior art devices of this general type, which has flexible options in terms of the extent of cascading, and a reduction in circuitry expenditure and complication.

With the foregoing and other objects in view there is provided, in accordance with the invention, a cascadable switch configuration. The switch configuration contains sets of switches. Each of the sets of switches include a switching region having an input and an output, an output side having an output terminal connected to the output of the switching region, and an input side having a call-up terminal and at least one inquiry terminal disposed beside the call-up terminal. The call-up terminal is connected to the input of the switching region and through the switching region the call-up region is coupled to the output terminal being a geometrically associated output terminal. The call-up terminal is geometrically disposed at a same position beside the inquiry terminal. The input side further has at least one reach-through terminal being geometrically connected to the output side at a same position as the call-up terminal is on the input side.

In accordance with the invention the object is attained in that, a given geometrical positioning of the call-up, inquiry and reach-through terminals is observed on all the sets of switches. The geometrically established positioning of the at least one reach-through terminal disposed on the input side is disposed on the output side which at the same time defines the transition to the input side of the next following set of switches, at the established geometrical positioning of the call-up terminal thereof.

In this respect the term set of switches in accordance with the present invention is used to denote a digital or analog switching region including its solder or plug connections on a circuit board or another carrier element. A digital switch set has at least one switching section, that is to say a mechanical, electromechanical or electronic switch, whereby the switching section can either be blocked or switched free, that is to say OFF or ON states can be produced. A plurality of switching sections preferably involves binary weighting. An analog switching region includes a steplessly or stepwise adjustable potentiometer.

In the case of a plurality of switching sections per set of switches, the switching sections which are defined in terms of their weighting or other criteria are each switched to a respective inquiry line which is associated with a criterion and which is passed through by all cascaded sets of switches. Each set of switches has its own call-up terminal allocated thereto by way of reach-through terminals. Sets of switches which have a number N of reach-through terminals and of the same geometrical configuration in respect of the input and output sides make it possible to construct a cascadable configuration which can contain a total of a maximum of (N+1) sets of switches. Because of the identical terminal geometry, any sets of switches can be connected in any sequence in series (cascaded). That considerably reduces the wiring expenditure.

Other features which are considered as characteristic for the invention are set forth in the appended claims.

Although the invention is illustrated and described herein as embodied in a cascadable configuration of sets of switches, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a structure, in principle, of a set of switches with a geometrical configuration of terminals on its input and output sides according to the invention; and

FIG. 2 is a schematic diagram of cascaded sets of switches as shown in FIG. 1 having regard to a differing configuration of a switching regions in the individual sets of switches.

### DESCRIPTION OF THE PREFERRED EMBODIMENTS

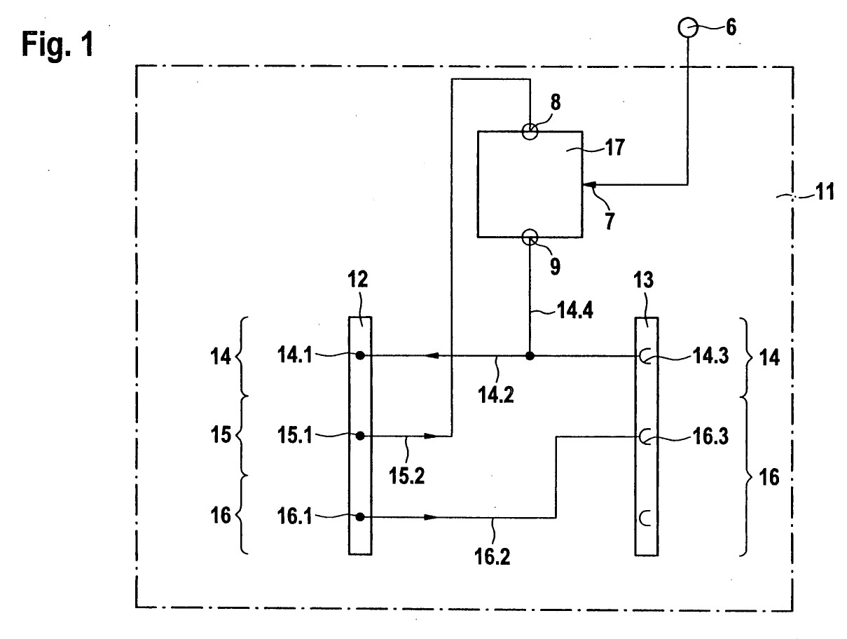

Referring now to the figures of the drawing in detail and first, particularly, to FIG. 1 thereof, there is shown a set of switches 11 having a switching region 17 and on its input side 12 and on its output side 13 three different terminal regions 14, 15, 16, more specifically for inquiry 14, call-up 15 and reach-through 16. They are disposed in mutually juxtaposed relationship along a line. In that respect, further functions can be embodied between the individual terminals if the cascading option described hereinafter is not impeded thereby. Each of those regions can have a plurality of terminals or lines if the function of the switching region 17 requires that. The reach-through region 16 limits the cascading length by way of the number of its reach-through lines 16.2.

In the call-up region 15 a call-up terminal 15.1 is connected by way of a call-up line 15.2 to an input 8 of the switching region 17 of the set of switches 11.

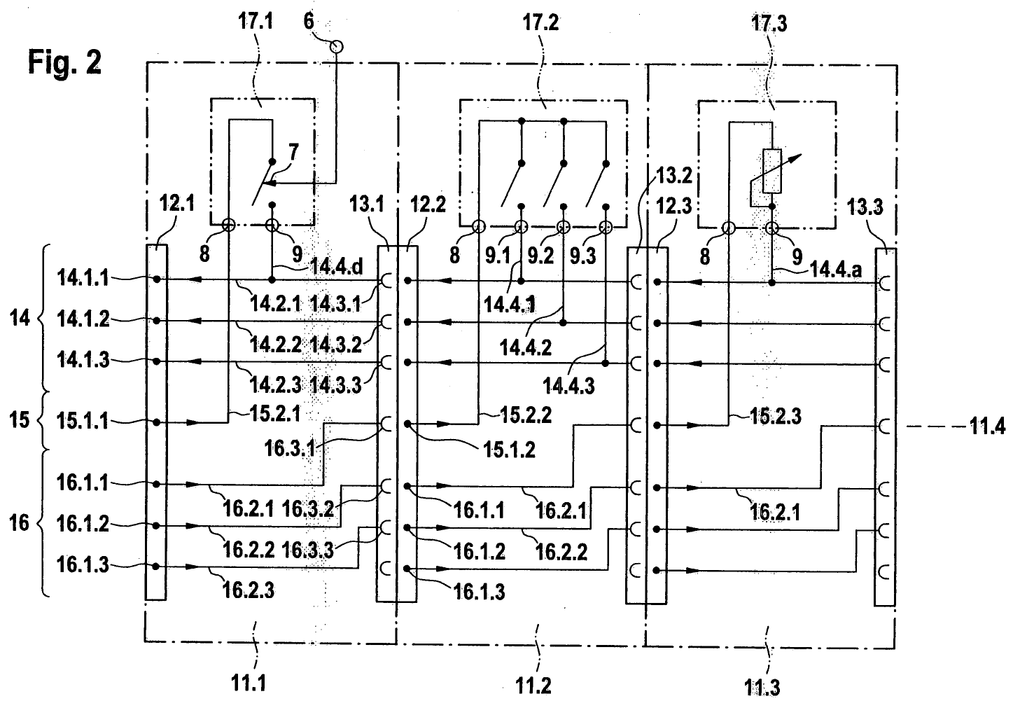

Actuation of the switching region 17 is effected by way of a functional control parameter 7, that is to say optionally pressure or temperature from a sensor 6. Each switching region 17 symbolizes a switching section with an electronic, mechanical, or electromechanical switch with the switching states ON and OFF or the use of binary-coded switching sections or analog switches, as described in greater detail in FIG. 2 hereinafter.

An input-side inquiry terminal 14.1 is passed by way of its inquiry line 14.2 and an output line 14.4 to an output 9 of the switching region 17 and also to an output-side inquiry terminal 14.3. In that way the instantaneous switching state of the switching region 17, if it is called up by way of the call-up terminal 15.1 and the associated call-up line 15.2, can be interrogated at the inquiry terminal 14.1. The inquiry terminal 14.1 is geometrically at the same position as the output-side terminal 14.3.

The input-side reach-through terminal 16.1 is connected by way of the reach-through line 16.2 to the output-side reach-through terminal 16.3 which, when a further such set of switches 11 is subsequently connected, corresponds there to the position of the input-side call-up terminal 15.1. By virtue of that displacement and because solely the call-up line 15.2 is not passed through, the set of switches 11 at the output side has only the inquiry region 14 which passes through directly and the reach-through region 16 which passes through in displaced relationship. Because of the system layout involved a socket is also shown on the output side 13 of the set of switches 11 in the reach-through region 16 but it is not occupied.

FIG. 2 shows a cascade of three sets of switches 11.1, 11.2 and 11.3 which each involve the structure in principle in accordance with the set of switches 11 shown in FIG. 1. The wiring of the sets of switches 11.1, 11.2 and 11.3 to each other represents a parallel bus structure.

The three switching regions 17.1-17.3 of the sets of switches 11 show possible forms of the configuration of their switches. The switching region 17.1 contains a digital switch and therefore has only an ON and OFF state. The next set of switches 11.2 has a switching region 17.3 with three switching sections, the switching state of which can represent a binary coding. The switching region 17.3 involves an analog switch, here a steplessly adjustable potentiometer.

The input side 12.1, 12.2, 12.3 of each of the sets of switches 11.1-11.3 in the illustrated embodiment has a call-up input, for example a call-up terminal 15.1.1 for its switching region 17.1, three inquiry terminals 14.1.1-14.1.3 for a maximum of three switching sections, as in the case by way of example of the switching region 17.2, and three reach-through terminals 16.1.1-16.1.3 for a maximum of three sets of switches 11.2, 11.3 and optionally 11.4, which are cascaded on to the first set of switches 11.1.

By virtue of the use of N=3 input-side reach-through terminals 16.1.1-16.1.3 therefore the cascaded configuration illustrated here can be expanded to a total of four sets of switches 11, by the addition of a further set of switches 11.4.

In the set of switches 11.1 the call-up line 15.2.1 connects the call-up terminal 15.1.1 to the input 8 of its switching region 17.1. A corresponding consideration applies for the call-up lines 15.2.2 and 15.2.3 in the further sets of switches 11.2 and 11.3.

The inquiry lines 14.2 associated with the respective input-side inquiry terminals 14.1 are passed through by way of all sets of switches 11 and end at the output 13 of the last set of switches 11 of the cascade at the corresponding sockets 14.3.1 and so forth.

In the case of the set of switches 11.1 the output 9 of the switching region 17.1, which here is digital, is wired by way of the output line 14.4.d to the inquiry line 14.2.1 and thus to the inquiry terminal 14.1.1. In the case of the set of switches 11.2 the binary-weighted output lines 14.4.1, 14.4.2 and 14.4.3 of the three switching sections of the switching region 17.2 are connected to the corresponding inquiry lines 14.2.1, 14.2.2, 14.2.3. The output of the potentiometer in the analog set of switches 11.3 is wired to the inquiry line 14.2.1 by way of the output line 14.4.a.

The switching region 17.1 with only one switching section can be passed on the output side to any one of the inquiry terminals 14.1.1-14.1.3 or to an additional inquiry terminal which is provided only for single switching sections. In the illustrated embodiment the analog switching region 17.3 is also connected to one of the inquiry lines 14.2 which moreover are occupied by digital switching sections. That is admissible because it is known at the control side whether the set of switches 11.3 is actuated precisely by way of the reach-through terminal 16.1.2. Then, at the inquiry terminal 14.1.1, the configuration is to be switched over from digital evaluation to analog or at least quasi-analog level measurement. In order to avoid such a switching-over effect, it may be desirable, in a departure from FIG. 2, to provide an additional inquiry line only for analog switching regions 17.3.

The wiring of the input-side reach-through terminals 16.1.1-16.1.3 to the respective output side 13 is implemented in the same manner for all sets of switches 11. The input-side reach-through terminal 16.1.1 is connected by way of the reach-through line 16.2.1 to the output-side reach-through terminal 16.3.1 which in turn on the input side 12.2 of the following set of switches 11.2 corresponds to the call-up terminal 15.1.2 thereof. The adjacent reach-through line 16.2.2 correspondingly connects the input-side reach-through terminal 16.1.2 to the output-side terminal 16.3.2 which in the subsequent set of switches 11.2 leads to the reach-through terminal 16.1.1 and in the next following set of switches 11.3 to the inquiry line 15.2.3 thereof. The foremost reach-through terminal 16.1.3 is wired by way of the reach-through line 16.2.3 to the terminal 16.3.3 of the first set of switches 11.1 so that by way of the reach-through line 16.2.2 of the second set of switches 11.2 and by way of the reach-through line 16.2.3 of the third set of switches 11.3 it reaches the call-up line in the last set of switches 11.4.

A cascadable configuration of sets of switches 11 therefore has call-up 15.1, inquiry 14.1 and reach-through terminals 16.1 in a defined mutual configuration. The switching region 17 of each set of switches 11 can have a digital, binary-coded or analog switch. A reduction in the complexity of the cascade circuit is achieved by way of a parallel bus-like connection of at least one input-side reach-through terminal 16.1 to an output-side reach-through terminal 16.3 which in a subsequent set of switches 11 is disposed at the geometrical position of the call-up terminal 15.1 thereof. Therefore it is possible to connect downstream of the first set of switches 11 (cascade) as many sets of switches 11 as there are reach-through lines 16.2 on the sets of switches 11.

This application claims the priority, under 35 U.S.C. § 119, of German patent application No. 103 33 911.6, filed Jul. 25, 2003; the entire disclosure of the prior application is herewith incorporated by reference.

1. A cascadable switch configuration, comprising:
sets of switches, each including:
a switching region having an input and an output;
an output side having an output terminal connected to said output of said switching region; and
an input side having a call-up terminal and at least one inquiry terminal disposed beside said call-up terminal, said call-up terminal connected to said input of said switching region and through said switching region said call-up region is coupled to said output terminal being a geometrically associated output terminal, said call-up terminal geometrically disposed at a same position beside said inquiry terminal, said input side further having at least one reach-through terminal being geometrically connected to said output side at a same position as said call-up terminal is on said input side.

2. The cascadable switch configuration according to claim 1,
wherein said switching region of one of said sets of switches has a digital switch.

3. The cascadable switch configuration according to claim 1,
wherein said switching region of one of said sets of switches has a number of switching sections.

4. The cascadable switch configuration according to claim 3,
wherein said switching sections are binary-weighted.

5. The cascadable switch configuration according to claim 1,
wherein said switching region of one of said sets of switches has an analog switch.

6. The cascadable switch configuration according to claim 5,
wherein said analog switch is a potentiometer.

7. The cascadable switch configuration according to claim 1,
wherein said switching region of each of said sets of switches passes to a same said inquiry terminal in each of said sets of switches.

8. The cascadable switch configuration according to claim 1,
wherein said at least one inquiry terminal is one of a plurality of inquiry terminals; and
further comprising inquiry lines connected between said inquiry terminals and said output side.

9. A cascadable switch configuration, comprising:
sets of switches, each including:
a switching region having an input and an output;
an output side having a first output terminal connected to said output of said switching region and a second output terminal; and
an input side having a call-up terminal and at least one inquiry terminal disposed beside said call-up terminal, said call-up terminal connected to said input of said switching region and through said switching region said call-up region is coupled to said first output terminal, said first output terminal geometrically disposed at a same position on said output side as said inquiry terminal is disposed on said input side, said call-up terminal geometrically disposed at a same position beside said inquiry terminal, said input side further having at least one reach-through terminal connected to said second output terminal, said second output terminal disposed geometrically at a same position on said output side as said call-up terminal is on said input side.
